(19) United States
(12) Patent Application Publication
(10) Pub. No.: US 2025/0058729 A1
(43) Pub. Date: Feb. 20, 2025

(54) CRASH BOX FOR A BUMPER ARRANGEMENT OF A MOTOR VEHICLE AND A BUMPER ARRANGEMENT OF A MOTOR VEHICLE WITH TWO SUCH CRASH BOXES AND A METHOD FOR PRODUCING SUCH A BUMPER ARRANGEMENT

(71) Applicant: BENTELER AUTOMOBILTECHNIK GMBH, PADERBORN (DE)

(72) Inventor: TOBIAS SVANTESSON KAVIK, OSLO (NO)

(73) Assignee: BENTELER AUTOMOBILTECHNIK GMBH, PADERBORN (DE)

(21) Appl. No.: 18/805,565

(22) Filed: Aug. 15, 2024

(30) Foreign Application Priority Data
Aug. 16, 2023 (EP) 23191640.4

(51) Int. Cl. B60R 19/34

(52) U.S. Cl. CPC B60R 19/34

(57) ABSTRACT

A crash box for a bumper arrangement of a motor vehicle. The crash box includes at least one outer hollow chamber, at least one inner hollow chamber, a vehicle-side end portion, and a bumper-side front portion. The at least one outer hollow chamber is connected to the at least one inner hollow chamber to form a closed multi-chamber profile in the vehicle-side end portion. The at least one outer hollow chamber is separated and spaced apart from the at least one inner hollow chamber in the bumper-side front portion. In the vehicle-side end portion, the at least one outer hollow chamber and the at least one inner hollow chamber each have a partition which delimits the at least one outer hollow chamber and the at least one inner hollow chamber on an inner side.

### CROSS REFERENCE TO PRIOR APPLICATIONS

Priority is claimed to European Patent Application No. EP 23191640.4, filed Aug. 16, 2023. The entire disclosure of said application is incorporated by reference herein.

### FIELD

The present invention relates to a crash box for a bumper arrangement of a motor vehicle, to a bumper arrangement of a motor vehicle comprising two such crash boxes, and to a method for producing such a bumper arrangement.

### BACKGROUND

Crash boxes and bumper arrangements are generally used in all motor vehicles and are intended, in the event of a crash, to absorb the energy introduced via the bumper arrangement in the crash boxes through corresponding folding or deformation of the crash boxes and to transmit excess energy into the frame or the vehicle longitudinal member of the motor vehicle in order to thus direct the energy introduced into the motor vehicle by the crash around the passenger compartment and to minimize damage to the passenger compartment and thus to reduce the risk of injury to the passengers.

In the typical tests which a bumper arrangement must pass so that the vehicle can pass insurance tests, the folding of the crash boxes must meet corresponding specifications. It is therefore important to be able to coordinate the force level of the maximum peaks during the folding of the crash boxes. In addition to the coordination of the profile geometry of the wall thicknesses to the use of trigger influences and the position, quantity and depth thereof, further measures must be taken to optimize the folding and energy absorption and energy transmission of the crash boxes.

The joining connections between the crash boxes and a crossmember of the bumper arrangement must in particular not be damaged or destroyed in the event of a crash so that the crash boxes fold in accordance with the specifications and excess energy is transmitted into the frame or the vehicle longitudinal member of the motor vehicle.

WO 2007/121896 A2 describes a bumper arrangement comprising a crash box which is bent toward a central region of a crossmember of the bumper arrangement and which is screwed to the crossmember. In the case of that bumper arrangement, however, the screw connections between the crash box and the crossmember are subjected to an extremely high loading in the event of a crash in which the main force is introduced between the two crash boxes into the crossmember of the bumper arrangement, there is therefore the danger that the screw connections are damaged and possibly even completely destroyed in the event of a crash so that a folding of the crash box in accordance with the specifications can no longer be ensured. A targeted transmission of crash energy into the vehicle frame around the passenger compartment is consequently also no longer ensured. This can considerably increase the risk of injury for people in the passenger compartment.

WO 94/27841 A1 describes a bumper arrangement in which the contact surface between a crash box and a crossmember of the bumper arrangement in the joining region is reduced. In the event of a crash in which the main force is introduced between the two crash boxes into the crossmember of the bumper arrangement, the joining regions are here also subjected to extremely high loadings which can lead to damage in, and possibly to destruction of, the joining connections. A targeted transmission of crash energy into the vehicle frame around the passenger compartment is consequently also no longer ensured in the case of that bumper arrangement. This can again considerably increase the risk of injury for people in the passenger compartment.

EP 0 894 675 A1 describes a bumper arrangement comprising a crash box consisting of a single-chamber profile. An inner wall and an outer wall of the crash box are here bent away from the latter and are likewise joined to a crossmember of the bumper arrangement, as are a bottom wall and a top wall of the crash box. In the event of a crash in which the main force is introduced between the two crash boxes into the crossmember of the bumper arrangement, the joining regions are here also subjected to high loadings which, although distributed over a relatively large region of the crossmember, can still also lead to damage in, and possibly to destruction of, the joining connections. The folding behavior of the hollow chamber, which is open toward the crossmember, of the crash box is in particular considerably less favorable and less predictable. A targeted transmission of crash energy into the vehicle frame around the passenger compartment is consequently also no longer ensured in the case of that bumper arrangement. This can, however, also considerably increase the risk of injury for people in the passenger compartment in the case of that bumper arrangement.

US 2015/108775 A1 describes a crash box where improvement is required in order to make the joining connections between the crash boxes and the crossmember of a bumper arrangement more resistant to destruction in the event of a crash.

There is therefore generally still an increased need to make the joining connections between the crash boxes and the crossmember of a bumper arrangement more resistant to destruction in the event of a crash in which the main force is introduced between the two crash boxes into the crossmember of the bumper arrangement. Welded connections should in particular be avoided because cracks occur within the welded connections or the heat affected zones thereof in the event of a crash, which lead to a failure of the crash management system of the bumper arrangement.

### SUMMARY

An aspect of the present invention is to provide a crash box for a bumper arrangement of a motor vehicle in which the folding in the event of a crash in which the main force is introduced between the two crash boxes into the crossmember of the bumper arrangement and the energy transmission into the motor vehicle frame are further optimized and improved, a probability of failure of the crash management system or of the bumper arrangement and a probability of destruction of the joining connection between the crash boxes and the crossmember of a bumper arrangement being considerably minimized compared with the prior art. An aspect of the present invention is also to provide a corresponding bumper arrangement comprising such crash boxes and a method for producing such a bumper arrangement.

In an embodiment, the present invention provides a crash box for a bumper arrangement of a motor vehicle. The crash box includes at least one outer hollow chamber, at least one inner hollow chamber, a vehicle-side end portion, and a bumper-side front portion. The at least one outer hollow chamber is connected to the at least one inner hollow chamber so as to form a closed multi-chamber profile in the vehicle-side end portion. In the bumper-side front portion, the at least one outer hollow chamber is separated and spaced apart from the at least one inner hollow chamber. In the vehicle-side end portion, the at least one outer hollow chamber and the at least one inner hollow chamber each comprise a partition which delimits the at least one outer hollow chamber and the at least one inner hollow chamber on an inner side.

### BRIEF DESCRIPTION OF THE DRAWINGS

The present invention is described in greater detail below on the basis of embodiments and of the drawings in which:

FIG. 1 shows a first exemplary embodiment of a crash box according to the present invention in a plan view from below;

FIG. 2 shows the exemplary embodiment of FIG. 1 in a perspective view of the bumper-side end of the crash box;

FIG. 3 shows an exemplary embodiment of a bumper arrangement according to the present invention in a perspective view of its one end at which it is joined to a crash box of FIGS. 1 and 2;

FIG. 4 shows a further exemplary embodiment of a bumper arrangement according to the present invention in a view from above of its one end at which it is joined to a crash box according to the present invention;

FIG. 5 shows a) a cross-sectional illustration of a front portion of an exemplary embodiment of a crash box according to the present invention, and b) a cross-sectional illustration of an end portion of the exemplary embodiment of the crash box shown in FIG. 5 a);

FIG. 6 shows a) a cross-sectional illustration of a front portion of an exemplary embodiment of the crash box, and b) a cross-sectional illustration of an end portion of the exemplary embodiment of the crash box of FIGS. 1 and 2 or of the crash box of FIG. 5 a);

FIG. 7 shows a) a cross-sectional illustration of a front portion of a further exemplary embodiment of a crash box according to the present invention, and b) a cross-sectional illustration of an end portion of the exemplary embodiment of the crash box shown in FIG. 7 a);

FIG. 8 shows an exemplary embodiment of a bumper arrangement according to the present invention in a view from above of its one end at the beginning of a center pole impact between the two crash boxes of the bumper arrangement;

FIG. 9 shows the exemplary embodiment of a bumper arrangement according to the present invention of FIG. 8 in a view from above of its one end during a center pole impact between the two crash boxes of the bumper arrangement;

FIG. 10 shows a further exemplary embodiment of a crash box according to the present invention in a plan view from one side; and

FIG. 11 shows an exemplary embodiment of a bumper arrangement according to the present invention.

### DETAILED DESCRIPTION

The crash box according to the present invention for a bumper arrangement of a motor vehicle is distinguished in that the crash box comprises at least one outer hollow chamber and at least one inner hollow chamber and a vehicle-side end portion and a bumper-side front portion, the at least one outer hollow chamber being connected to the at least one inner hollow chamber and forming a closed multi-chamber profile in the vehicle-side end portion, whereas, in the bumper-side front portion, the at least one outer hollow chamber is separated and spaced apart from the at least one inner hollow chamber. In this case, in the end portion, the at least one outer hollow chamber and the at least one inner hollow chamber each have a partition which delimit the at least one outer hollow chamber and the at least one inner hollow chamber on the inner side, these partitions can, for example, be spaced apart from one another and form, together with an upper web and lower web connecting the at least one outer hollow chamber and the at least one inner hollow chamber, a further hollow chamber in the end portion. A crash box of this kind can be produced in a simple manner from a multi-chamber hollow profile in which the further hollow chamber is arranged between the at least one outer and the at least one inner hollow chamber. For this purpose, a slot is introduced in the front region of the multi-chamber hollow profile, between the at least one outer and the at least one inner hollow chamber, in the further hollow chamber. This produces a crash box having closed inner and outer hollow chambers in the front region. The region of attachment between the crash box and the crossmember can subsequently also be widened, for example, by bending or kinking of the closed inner and/or outer hollow chambers.

The design of the crash box according to the present invention provides that, in the event of a crash in which the main force is introduced between the two crash boxes into the crossmember of the bumper arrangement, the joining connection of both the at least one outer hollow chamber and the at least one inner hollow chamber is loaded considerably less than in the case of the crash boxes known from the prior art. This has the result that the risk of the crash management system of a bumper arrangement failing and the joining connections being destroyed is considerably minimized since the at least one outer and the at least one inner hollow chamber are loaded independently of one another on account of the separation and spacing apart thereof in the front portion and thus there are independent energy dissipation paths. These different energy dissipation paths also make it possible to achieve a more targeted folding of the crash box in the event of such a crash and introduction of excess crash energy into the vehicle body around the passenger compartment. The crash box according to the present invention therefore considerably increases the safety of people within the passenger compartment since the risk of the crash management system failing and the bumper arrangement collapsing in an uncontrolled manner is considerably minimized. The crash box according to the present invention is particularly effective when the joining connections used are welded connections since a large-area materially bonded connection between crossmember and crash box is here achieved, as a result of which the targeted folding of the crash box in the event of such a crash and the introduction of excess crash energy into the vehicle body around the passenger compartment can be calculated and predicted particularly well. What is particularly advantageous in the case of the crash box according to the present invention is the one-part design thereof, which also contributes to improved performance in the event of a crash, since this can also considerably minimize the number of weld seams or the length thereof. A lower heat input is thereby provided in the production of the welded connections, as a result of which the danger of cracking in the heat affected zones can be minimized overall. The one-part design of the crash box also achieves lower parts logistics.

According to a first advantageous design of the present invention, there can be two alternative embodiments. In the vehicle-side end portion, the at least one outer hollow chamber may be connected in a horizontal direction to the at least one inner hollow chamber and form a closed multi-chamber profile, whereas, in the bumper-side front portion, the at least one outer hollow chamber is separated and spaced apart from the at least one inner hollow chamber in the horizontal direction. In the vehicle-side end portion, the at least one outer hollow chamber may be connected in a vertical direction to the at least one inner hollow chamber and form a closed multi-chamber profile, whereas, in the bumper-side front portion, the at least one outer hollow chamber is separated and spaced apart from the at least one inner hollow chamber in the horizontal direction.

According to a further advantageous design of the present invention, both the at least one inner and the at least one outer hollow chamber are closed over their entire longitudinal extent from a bumper-side end up to a vehicle-side end. Hollow profiles closed in this way have a particularly good and predictable folding property in the event of a crash and can introduce the excess crash energy into the vehicle body around the passenger compartment particularly well. The crash box according to the present invention therefore contributes to increased safety of the people within the passenger compartment of the motor vehicle.

As an alternative, it is also possible for the at least one outer hollow chamber or the at least one inner hollow chamber to be open over its longitudinal extent in the front portion, in particular to be in the form of an open C-shaped profile. Such a design of the crash box in particular provides a good and predictable folding property of the crash box, with the result that a crash box of this kind also introduces excess crash energy into the vehicle body around the passenger compartment particularly well. This in particular applies if the at least one outer hollow chamber or the at least one inner hollow chamber is open over its longitudinal extent in the front portion up to the respective at least one other hollow chamber. Such a design of the crash box therefore also contributes to increased safety of the people within the passenger compartment of the motor vehicle.

According to a particularly advantageous design of the crash box according to the present invention, the at least one outer hollow chamber in the front portion has a longitudinal axis which forms an angle α smaller than 40° with respect to a longitudinal axis of the at least one inner hollow chamber, the angle α can, for example, be greater than 3°. Due to this design of the crash box according to the present invention, the at least one inner and the at least one outer hollow chamber are at an increasingly further spacing apart from one another in the front portion, the distance increasing linearly toward the bumper-side end of the crash box. The crash box is thereby widened considerably in the region where it joins the crossmember. This has the result that the force on the joining connections, and in particular when using welded connections on the weld seams, is reduced considerably. This design of the crash box according to the present invention therefore prevents an uncontrolled collapsing of the crash management system or destruction of the joining connections between crash box and crossmember in the event of a crash in which the main force is introduced between the two crash boxes into the crossmember of the bumper arrangement, and this in turn increases the safety of people within the passenger compartments of a motor vehicle comprising such crash boxes.

It may alternatively also be provided that, in the front portion, the at least one outer hollow chamber and the at least one inner hollow chamber are at a continuously increasing distance toward the bumper-side end, without there being corresponding longitudinal axes of hollow chambers forming a constant angle. The at least one inner and/or the at least one outer hollow chamber may in particular be accordingly bent in the front portion. These bends can here have various forms, such that both a bending radius and a bend that becomes continuously larger may be provided. It is also possible for the course of the bend to change direction. Due to such a design of the crash box according to the present invention, the at least one inner and the at least one outer hollow chamber are also at an increasingly further spacing apart from one another in the front portion, however, the distance between the hollow chambers does not increase linearly toward the bumper-side end of the crash box. The crash box is here also widened considerably in the region where it joins the crossmember. This also has the result here that the force on the joining connections, and in particular when using welded connections on the weld seams, is reduced considerably. This design of the crash box according to the present invention therefore also prevents an uncontrolled collapsing of the crash management system or destruction of the joining connections between crash box and crossmember in the event of a crash in which the main force is introduced between the two crash boxes into the crossmember of the bumper arrangement, and this in turn increases the safety of people within the passenger compartments of a motor vehicle comprising such crash boxes.

It has here proven to be particularly advantageous for the front portion to extend over ⅕ to ⅔ of the total length of the crash box. Such a design of the crash box achieves a particularly good crash management of the bumper arrangement. A particularly good and predictable folding property in the event of a crash is thereby achieved and excess crash energy is introduced into the vehicle body around the passenger compartment particularly well. This design of the crash box according to the present invention therefore contributes to increased safety of the people within the passenger compartment of the motor vehicle.

In order to separate and space apart the at least one inner and at least one outer hollow chamber in the front region, in the front portion, the at least one outer hollow chamber is spaced apart from the at least one inner hollow chamber by a slot which can, for example, be rounded in the direction of the end portion, in particular is rounded by a radius, this radius corresponding to at least the wall thickness of the hollow chambers in the end portion. Such a slot can be introduced particularly simply and effectively, in particular in terms of tooling by using milling tools or punching tools. Such machining techniques or machining tools can in particular be used to simply and precisely generate appropriate rounded portions or radii toward the end portion.

As an alternative, it is possible that, in the front portion, a further hollow chamber is arranged between the inner and outer hollow chamber within the slot, with the result that separate slots are arranged between inner hollow chamber and further hollow chamber and further hollow chamber and outer hollow chamber, respectively.

In order to achieve a particularly good introduction of excess crash energy and in order to optimize the folding properties of the crash box, the hollow chambers in the front portion and/or in the end portion have predetermined deformation points on the inner side and/or on the outer side.

The same goal is pursued by the design of the present invention according to which, in the front portion, webs are arranged at the hollow chambers, in particular webs formed over the entire longitudinal extent of the front portion, beads as deformation elements being arranged in the webs. The beads can, for example, continue into the partitions and the upper and/or lower delimiting walls of the hollow chambers.

According to a further advantageous design of the crash box according to the present invention, the hollow chambers each separately have a constant width of at least 20 mm over their entire longitudinal extent from the vehicle-side end up to the bumper-side end. The constant width allows the crash management to be designed particularly well since the folding of the crash box and the introduction of excess crash energy into the vehicle body around the passenger compartment is thereby particularly predictable and calculable.

The bumper arrangement according to the present invention of a motor vehicle comprises two above-described crash boxes which are connected to one another by way of at least one crossmember. Such a bumper arrangement makes it possible to realize particularly good crash management in which the folding of the crash box and the introduction of excess crash energy into the vehicle body around the passenger compartment is particularly predictable and calculable so that the safety of people in the passenger compartment is increased considerably.

Even though inner and outer hollow chambers of the crash box have been discussed hitherto, which should be understood as direction details in relation to the installation position and the motor vehicle coordinate system (X, Y, Z), it is also possible in the context of the present invention for the crash box to be used installed rotated through 90° in the vehicle longitudinal axis (X) so that the inner and/or outer hollow chambers are inclined in the vehicle height direction instead of toward the vehicle sides.

A bumper arrangement according to the present invention may alternatively be designed so that:
a) the at least one outer hollow chamber is arranged closer to an end of the at least one crossmember than the at least one inner hollow chamber, or
b) the at least one outer hollow chamber of the crash boxes is arranged above the at least one inner hollow chamber.

According to a further advantageous design of the present invention, the at least one crossmember has a height which is greater than a cross-sectional height of the vehicle end portion of the crash boxes, the at least one outer hollow chamber of the crash boxes being arranged above the at least one inner hollow chamber and being supported on an upper fastening region of the at least one crossmember, whereas the at least one inner hollow chamber is supported on a lower fastening region of the at least one crossmember.

It has here proven to be advantageous for the crash boxes to be joined, for example, screwed or joined in a materially bonded manner, in particular welded, to the crossmember. Joining connections of this kind can be produced simply and advantageously from an economic perspective.

It is furthermore advantageous for the end portion of the crash boxes to be able to be joined, in particular able to be welded or screwed, to the motor vehicle, in particular to a longitudinal member of the motor vehicle, in particular able to be screwed to one another by way of flange plates. Joining connections of this kind can also be produced simply and advantageously from an economic perspective.

The method according to the present invention for producing an above-described bumper arrangement comprising two above-described crash boxes comprises the following method steps:
a) providing two multi-chamber hollow profiles comprising at least one outer hollow chamber and at least one inner hollow chamber,
b) introducing a slot into a front portion of the multi-chamber hollow profiles in order to separate and space apart the at least one outer hollow chamber from the at least one inner hollow chamber and produce two crash boxes,
c) providing two crash boxes, and
d) joining the two crash boxes to the at least one crossmember.

The joining can here be provided via various joining methods, such as screwing and in particular welding. There are multiple possible ways of connecting crossmember and crash boxes. The at least one inner and one outer hollow chamber may have overlapping front regions, via which the crash boxes engage around the crossmember at the top and bottom and via which the crash boxes can be joined, in particular screwed and/or welded, to the crossmember of the bumper arrangement. The at least one inner and one outer hollow chamber may be welded directly to the crossmember. It is possible in this case for these to be welded directly to the rear wall of the crossmember. The rear wall of the crossmember may also have apertures through which the at least one inner and one outer hollow chamber can be inserted in order to subsequently be welded to the front wall of the crossmember.

Further aspects, advantages, features and application possibilities of the present invention emerge from the following description of exemplary embodiments with reference to the drawings. All the features described and/or illustrated thereby form, on their own or in any desired expedient combination, the subject matter of the present invention, also irrespective of how they are summarized in the claims or how they relate back to preceding claims.

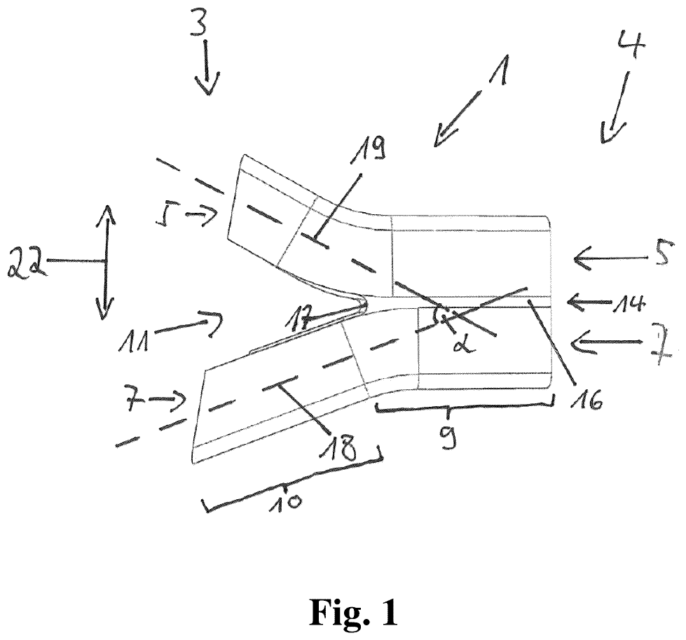

FIG. 1 shows a first exemplary embodiment of a crash box 1 according to the present invention in a plan view from below. The crash box 1 thereby comprises an outer hollow chamber 5 and an inner hollow chamber 7, which extend from a vehicle-side end 4 to a bumper-side end 3. The two hollow chambers 5 and 7 are here connected in a vehicle-side end portion 9 via a lower web 16.

At the end of the lower web 16 which faces toward the bumper-side end 3, the lower web 16 has a radius 17 at its termination. From here, the two hollow chambers 5 and 7 are separated and are spaced apart from one another in the horizontal direction 22 via a slot 11 in a bumper-side front portion 10. In this case, the slot 11 becomes continuously larger from its end pointing toward the vehicle-side end 4 of the crash box 1 at the radius 17 of the lower web 16 toward the bumper-side end 3. The two hollow chambers 5 and 7 are thus angled with respect to one another in the bumper-side front portion 10, a longitudinal axis 18 of the inner hollow chamber 7 forming an angle α of about 40° with respect to a longitudinal axis 19 of the outer hollow chamber 5.

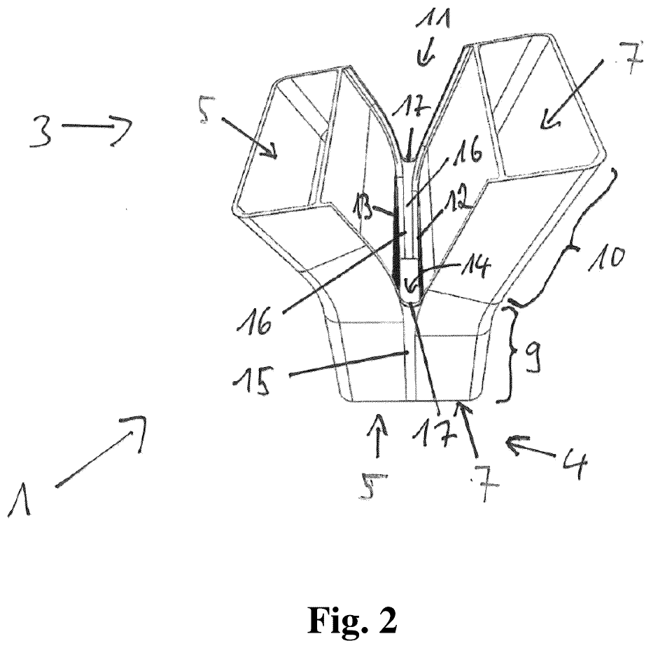

FIG. 1 also shows a further hollow chamber 14 which is arranged between the inner hollow chamber 7 and the outer hollow chamber 5 in the vehicle-side end portion 9 which is formed by the lower web 16 and an upper web 15, which is visible in FIG. 2 which illustrates a perspective view of the bumper-side end of the crash box 1 from above, and partitions 12 and 13. The partitions 12 and 13 here form the inner wall of the two hollow chambers 5 and 7 in the vehicle-side end region 9.

FIG. 2 also shows that both the inner hollow chamber 7 and the outer hollow chamber 5 are in the form of closed hollow chambers 5 and 7 over their entire longitudinal extent. The crash box 1 can then be joined, for example, welded, at the bumper-side end 3 to a crossmember 20 of a bumper arrangement via the inner hollow chamber 7 and the outer hollow chamber 5. At the vehicle-side end 4, the entire crash box 1 can also be joined, in particular welded, to the body of a motor vehicle, for example, to a longitudinal member of the motor vehicle.

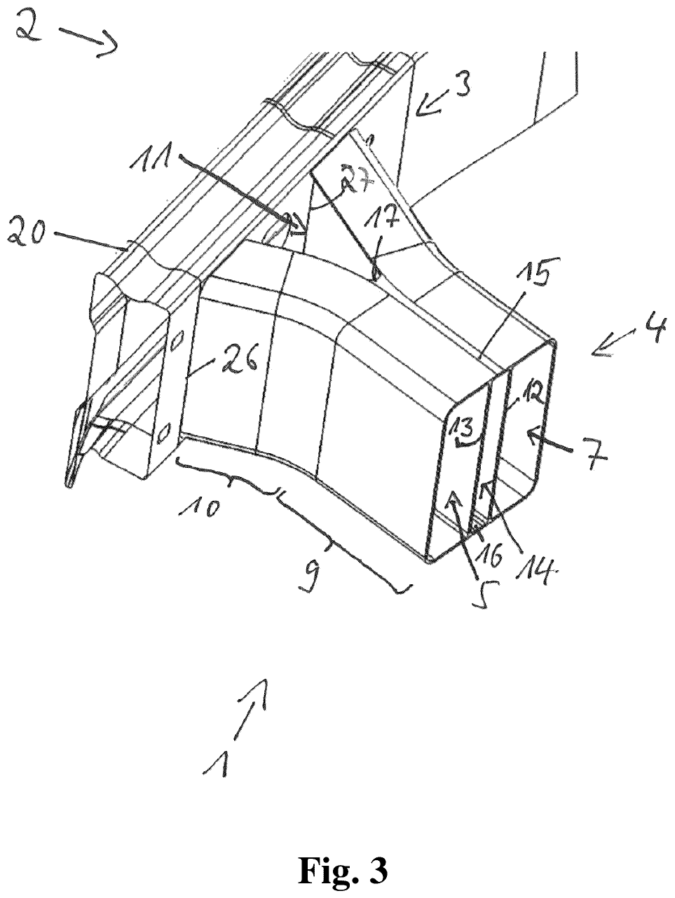

FIG. 3 shows the crash box 1 of FIGS. 1 and 2 in an exemplary embodiment of a bumper arrangement according to the present invention in a perspective view of its one end at which it has already been joined to a bumper arrangement 2 of a motor vehicle. The joining was here provided via a welded connection, forming a weld seam 26 between a crossmember 20 of the bumper arrangement 2 and the outer hollow chamber 5 in the bumper-side front portion 10. The weld seam 26 is here shown only in an outer region but can, for example, run over the entire closed region of the outer hollow chamber 5 toward the crossmember 20, with the result that the crossmember 20 and the outer hollow chamber 5 are connected to one another in a materially bonded manner over the entire periphery of the outer hollow chamber 5.

The inner hollow chamber 7 is joined analogously, in particular welded, to the crossmember 20 of the bumper arrangement 2 in the bumper-side front portion 10, a materially bonded connection over the entire periphery of the inner hollow chamber 7 also being provided here by a weld seam 27 between the crossmember 20 and the inner hollow chamber 7.

FIG. 3 clearly shows that, in the joined state of the bumper arrangement 2 according to the present invention, the crash box 1 is designed so that the two hollow chambers 5 and 7 are spaced apart from one another in the bumper-side front portion 10 by the slot 11, the slot 11 becoming continuously larger toward the crossmember 20 of the bumper arrangement 2. The total region of engagement between the crash box 1 and the crossmember 20 of the bumper arrangement 2 is thereby widened considerably, and therefore energy introduced in the event of a crash is introduced via the crossmember 20 into the crash box 1 over a considerably enlarged region, as a result of which a considerably more favorable force distribution is achieved.

The further hollow chamber 14 between the inner hollow chamber 7 and the outer hollow chamber 5 can also be seen in FIG. 3, the further hollow chamber 14 being formed by the inner partition 12 of the inner hollow chamber 7 and the inner partition 13 of the outer hollow chamber 5, and also the upper web 15 and the lower web 16 which connect the inner hollow chamber 7 to the outer hollow chamber 5.

The radius 17 of the upper web 15 at its bumper-side end 3 can also clearly be seen. The formation of this radius 17 enables a better force introduction into the body of the vehicle and more targeted folding of the crossmember 20 in the event of a crash.

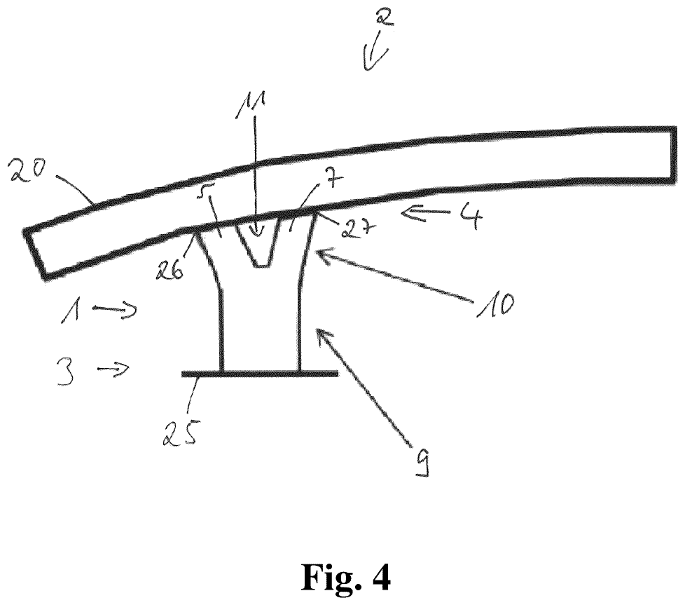

FIG. 4 shows a view from above of a schematic exemplary embodiment of a bumper arrangement 2 according to the present invention comprising a crossmember 20 which is joined to the bumper-side end 3 of a crash box 1 according to the present invention, to the inner hollow chamber 7 and the outer hollow chamber 5, via weld seams 27 and 26. At the vehicle-side end 4, the crash box 1 is also joined, in particular screwed or welded, to a longitudinal member 25 of a motor vehicle.

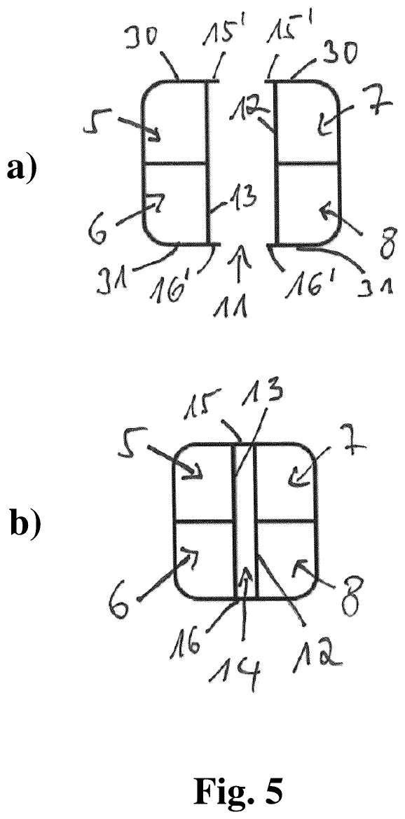

FIG. 5 a) shows a cross-sectional illustration of the bumper-side front portion 10 of an exemplary embodiment of a crash box 1 according to the present invention, whereas FIG. 5 b) shows the cross section of the vehicle-side end portion 9 of this exemplary embodiment. This exemplary embodiment shows that two closed inner hollow chambers 7 and 8 and two closed outer hollow chambers 5 and 6 are present. The slot 11 in the bumper-side front portion 10 can be seen in FIG. 5 a), the slot 11 separating and spacing apart the inner hollow chambers 7 and 8 from the outer hollow chambers 5 and 6. The inner hollow chambers 7 and 8 have a common inner partition 12 which here faces in the direction of a common inner partition 13 of the outer hollow chambers 5 and 6.

FIG. 5 b) shows that the two inner hollow chambers 7 and 8 are connected via an upper web 15 and a lower web 16 to the outer hollow chambers 5 and 6 in the vehicle-side end portion 9. The upper web 15 and the lower web 16 here form, together with the upper web 15 and the lower web 16, a further hollow chamber 14 arranged between the outer hollow chambers 5 and 6 and the inner hollow chambers 7 and 8.

FIG. 5 a) also shows webs 15′ and 16′ which emerge from the webs 15 and 16 shown in FIG. 5 b) by formation of the slot 11 and which continue upper delimiting walls 30 of the hollow chambers 5 and 7 and, respectively, lower delimiting walls 31 of the hollow chambers 6 and 8. Beads (not shown here), which continue into the inner partitions 12 and 13 and the upper and lower delimiting walls 30 and 31, can be introduced into these webs 15′ and 16′.

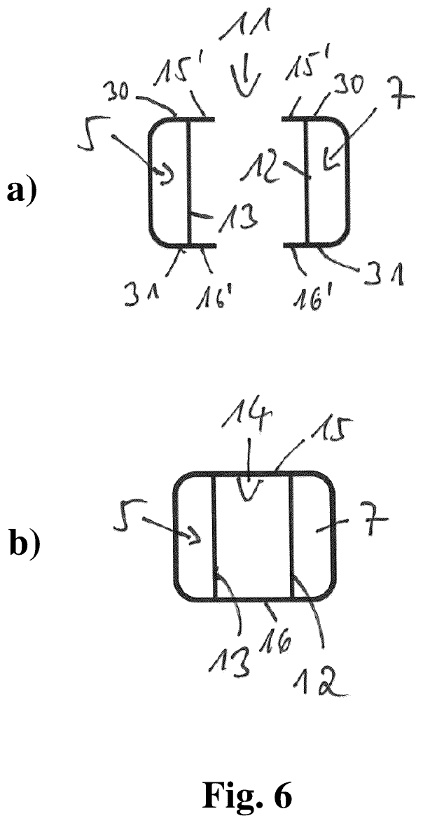

FIG. 6 a) and b) show a further exemplary embodiment of a crash box 1 according to the present invention, FIG. 6 a) showing the cross section of the bumper-side front portion 10, and FIG. 6 b) showing the cross section of the vehicle-side end portion 9. In this exemplary embodiment, only one inner hollow chamber 7 and one outer hollow chamber 5 are provided in accordance with the exemplary embodiment of FIGS. 1 and 2. In the cross section illustrated in FIG. 6 a), the inner hollow chamber 7 and the outer hollow chamber 5 are again spaced apart and separated from one another in the bumper-side front portion 10 by a slot 11. The hollow chambers 5 and 7 in this exemplary embodiment are also closed over their entire longitudinal extent so that the inner partitions 12 and 13 thereof face toward one another.

In the vehicle-side end portion 9, as illustrated in cross section in FIG. 6 a), the inner hollow chamber 7 and the outer hollow chamber 5 are again connected to one another via the upper web 15 and the lower web 16. The upper web 15 and the lower web 16 in this exemplary embodiment also form, together with the inner partitions 12 and 13 of the inner hollow chamber 7 and of the outer hollow chamber 5, a further hollow chamber 14.

Analogously to the exemplary embodiment of FIG. 5 a) and b), FIG. 6 a) shows webs 15′ and 16′ which emerge from the webs 15 and 16 shown in FIG. 6 b) by formation of the slot 11 and which continue upper delimiting walls 30 of the hollow chambers 5 and 7 and, respectively, lower delimiting walls 31 of the hollow chambers 5 and 7. Beads (not shown here), which continue into the inner partitions 12 and 13 and the upper and lower delimiting walls 30 and 31, can be introduced into these webs 15′ and 16′.

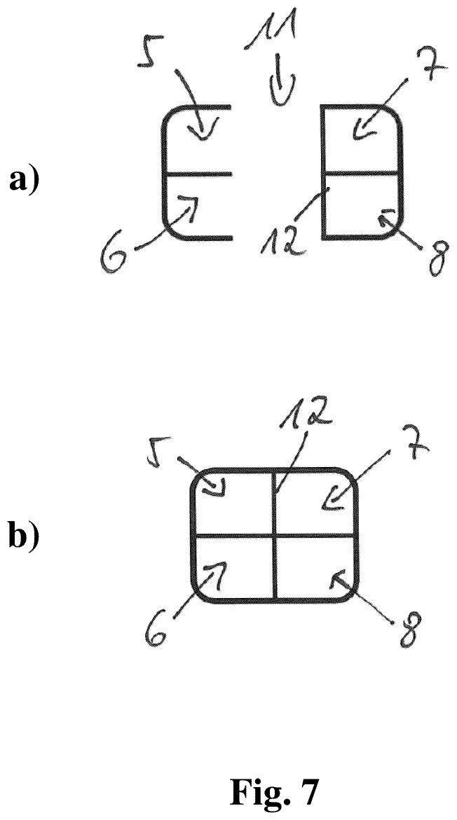

A further exemplary embodiment of a crash box 1 according to the present invention is illustrated in cross section in FIG. 7 a) and b). FIG. 7 a) here again shows the cross section in the bumper-side front portion 10 of the crash box 1, whereas FIG. 7 b) shows the cross section in the vehicle-side end portion 9 of the crash box 1. FIG. 7 b) shows that the crash box 1 again comprises two outer hollow chambers 5 and 6 and two inner hollow chambers 7 and 8. In this exemplary embodiment, the outer hollow chambers 5 and 6 have a common inner partition 12 with the inner hollow chambers 7 and 8. This exemplary embodiment of a crash box according to the present invention therefore manages without a further hollow chamber 14, as is provided in the exemplary embodiments of FIGS. 5 b) and 6 b).

In the bumper-side front portion 10, as illustrated in cross section in FIG. 7 a), the outer hollow chambers 5 and 6 are then open toward the inner hollow chambers 7 and 8 but are also separated and spaced apart therefrom by slot 11. The inner hollow chambers 7 and 8 in this exemplary embodiment are in the form of closed inner hollow chambers 7 and 8 and have the inner partition 12 as a termination toward the open outer hollow chambers 5 and 6.

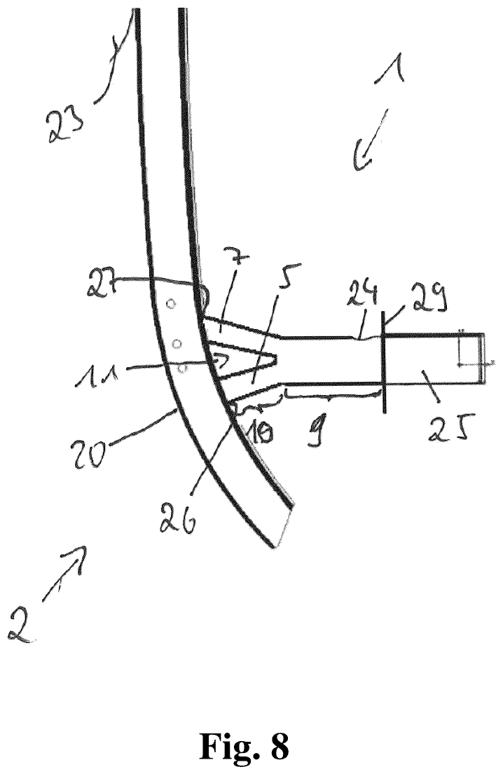

FIG. 8 shows a bumper arrangement 2 according to the present invention in a view from above of its left-hand end at the beginning of a center pole impact between the two crash boxes 1 of the bumper arrangement 2. It can here be seen that a crossmember 20 of the bumper arrangement 2 is struck by an obstacle 23 between the two crash boxes 1.

FIG. 8 shows that no action of force into the bumper arrangement 2 by the obstacle 23 has yet taken place, with the result that the crash boxes 1 still have their unchanged arrangement with respect to the crossmember 20 of the bumper arrangement 2, a closed inner hollow chamber 7 and a closed outer hollow chamber 5 being provided in this exemplary embodiment. The inner hollow chamber 7 and outer hollow chamber 5 which are separated and spaced apart from one another by slot 11 are connected in a materially bonded manner, via weld seams 26 and 27, to the crossmember 20 of the bumper arrangement 2 in the bumper-side front portion 10.

In the vehicle-side end portion 9 of the crash box 1 which is joined by way of flange plates 29 to a longitudinal member 25 of a motor vehicle, in the region of the inner hollow chamber, on the outer side thereof, the outer wall pointing toward the center of the bumper arrangement has a predetermined deformation point 24.

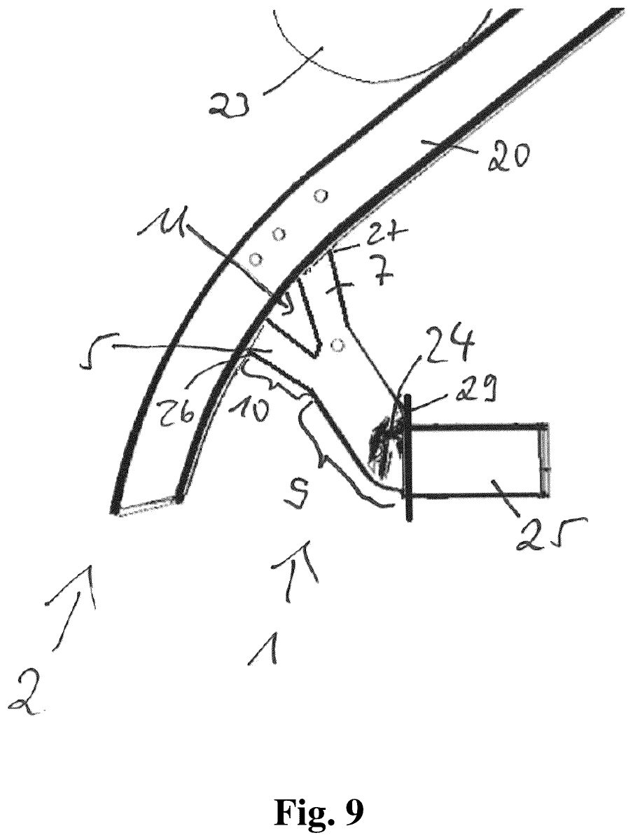

FIG. 9 shows the exemplary embodiment of a bumper arrangement 2 according to the present invention of FIG. 8 in a view from above of its left-hand end during a center pole impact between the two crash boxes 1 of the bumper arrangement 2. FIG. 9 shows that a targeted folding of the crash box 1 in its vehicle-side end portion 9 has taken place in the region of the predetermined deformation point 24, the materially bonded connections, by way of the weld seams 26 and 27, of the outer hollow chamber 5, and of the inner hollow chamber 7 in the bumper-side front portion 10 of the crash box 1 remaining undamaged. Due to the fact that the weld seams have a considerably wider engagement point with the crossmember 20 of the bumper arrangement 2 as a result of the design according to the present invention of the crash box 1, the energy introduced into the crossmember 20 is distributed over a larger region, in which the energy is introduced into the crash box, the force distribution also taking place over a larger region of the crossmember in the event of a crash, and therefore the probability of failure of the welded connection as a result of tearing of the weld seams 26 and 27 is minimized considerably.

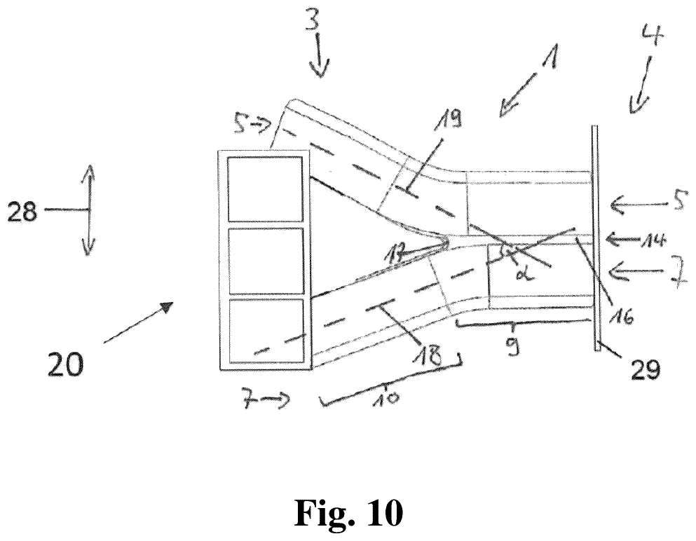

FIG. 10 shows an installation position of a crash box 1 according to the present invention in the motor vehicle, the installation position being rotated through 90° with respect to the previous embodiments, the inner hollow chamber 7 and the outer hollow chamber 5 being spaced apart from one another in the crossmember-side bumper-side front portion 10 in the vehicle height direction 28 rather than in the vehicle horizontal direction 22, with the result that a distance between the hollow chambers 5 and 7 which becomes larger running toward the crossmember 20 is formed.

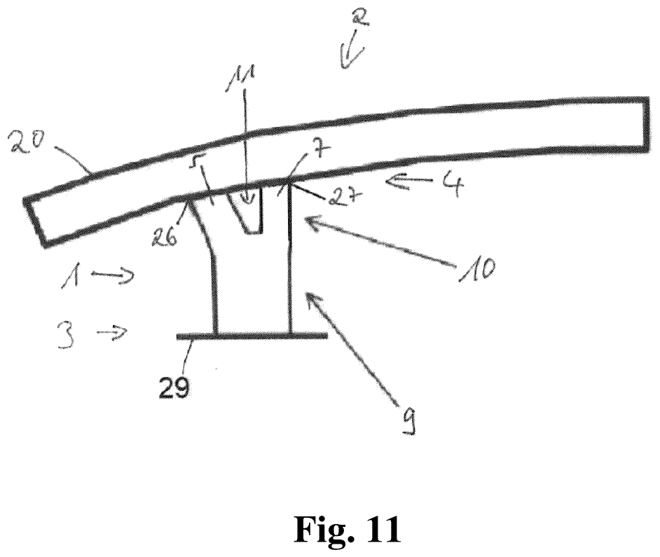

In contrast to the embodiment of FIG. 4, FIG. 11 shows that only one of the hollow chambers, and specifically the outer hollow chamber 5, is inclined or bent in the crossmember-side vehicle-side end portion 9, whereas the inner hollow chamber 7 runs substantially continuously rectilinearly between the two crash boxes.

In the exemplary embodiments of FIGS. 10 and 11, a respective flange plate 29 is arranged at the end of the vehicle-side end portion 9 in order to connect the crash box 1 to a vehicle longitudinal member, in particular to screw it to a flange plate arranged on a vehicle longitudinal member.

The present invention is not limited to embodiments described herein; reference should be had to the appended claims.

### LIST OF REFERENCE DESIGNATIONS

1 Crash box
2 Bumper arrangement
3 Bumper-side end
4 Vehicle-side end
5 Outer hollow chamber
6 Outer hollow chamber
7 Inner hollow chamber
8 Inner hollow chamber
9 Vehicle-side end portion
10 Bumper-side front portion
11 Slot
12 Inner partition
13 Inner partition
14 Hollow chamber
15 Upper web
15′ Web
16 Lower web
16′ Web
17 Radius
18 Longitudinal axis
19 Longitudinal axis
20 Crossmember
22 Horizontal direction
23 Obstacle
24 Predetermined deformation point
25 Longitudinal member
26 Weld seam
27 Weld seam
28 Vehicle height direction
29 Flange plate
30 Upper delimiting wall
31 Lower delimiting wall
α Angle

What is claimed is:

1-15. (canceled)

16. A crash box for a bumper arrangement of a motor vehicle, the crash box comprising:
at least one outer hollow chamber;
at least one inner hollow chamber;
a vehicle-side end portion; and
a bumper-side front portion,
wherein,
the at least one outer hollow chamber is connected to the at least one inner hollow chamber so as to form a closed multi-chamber profile in the vehicle-side end portion,
in the bumper-side front portion, the at least one outer hollow chamber is separated and spaced apart from the at least one inner hollow chamber, and
in the vehicle-side end portion, the at least one outer hollow chamber and the at least one inner hollow chamber each comprise a partition which delimits the at least one outer hollow chamber and the at least one inner hollow chamber on an inner side.

17. The crash box as recited in claim 16, further comprising:
an upper web;
a lower web; and
a further hollow chamber in the vehicle-side end portion,
wherein,
the upper web and the lower web connect the at least one outer hollow chamber and the at least one inner hollow chamber, and
the partitions are spaced apart from one another and form, together with the upper web and the lower web, the further hollow chamber in the vehicle-side end portion.

18. The crash box as recited in claim 16, wherein,
in the vehicle-side end portion, the at least one outer hollow chamber is connected in a horizontal direction or in a vertical direction to the at least one inner hollow chamber so as to form the closed multi-chamber profile, and
in the bumper-side front portion, the at least one outer hollow chamber is separated and spaced apart from the at least one inner hollow chamber in the horizontal direction or in the vertical direction.

19. The crash box as recited in claim 16, wherein,
the at least one outer hollow chamber is closed over an entire longitudinal extent thereof from a bumper-side end up to a vehicle-side end, and
the at least one inner hollow chamber is closed over an entire longitudinal extent thereof from the bumper-side end up to the vehicle-side end.

20. The crash box as recited in claim 16, wherein,
the at least one outer hollow chamber is open over a longitudinal extent thereof in a bumper-side front portion, or
the at least one inner hollow chamber is open over a longitudinal extent thereof in a bumper-side front portion.

21. The crash box as recited in claim 20, wherein the at least one outer hollow chamber is open over the longitudinal extent thereof in the bumper-side front portion up to the at least one inner hollow chamber.

22. The crash box as recited in claim 16, wherein,
the at least one outer hollow chamber has a longitudinal axis in the bumper-side front portion,
the at least one inner hollow chamber has a longitudinal axis in the bumper-side front portion, and
the longitudinal axis of the at least one outer hollow chamber forms an angle α which is smaller than 40° with respect to the longitudinal axis of the at least one inner hollow chamber.

23. The crash box as recited in claim 22, wherein the angle α is greater than 3°.

24. The crash box as recited in claim 16, wherein, in the bumper-side front portion, a distance between the at least one outer hollow chamber and the at least one inner hollow chamber continuously increases toward a bumper-side end.

25. The crash box as recited in claim 16, wherein the bumper-side front portion extends over ⅕ to ⅔ of a total length of the crash box.

26. The crash box as recited in claim 16, wherein, in the bumper-side front portion, the at least one outer hollow chamber is spaced apart from the at least one inner hollow chamber via a slot.

27. The crash box as recited in claim 26, wherein the slot is rounded in a direction of the vehicle-side end portion.

28. The crash box as recited in claim 27, wherein the slot is rounded in the direction of the vehicle-side end portion by a radius which corresponds to at least a wall thickness of the at least one outer hollow chamber and of the at least one inner hollow chambers in the vehicle-side end portion.

29. The crash box as recited in claim 16, further comprising, in the bumper-side front portion:
webs which are arranged at the at least one outer hollow chamber with beads being arranged in the webs as deformation elements; and
webs which are arranged at the at least one inner hollow chamber with beads being arranged in the webs as deformation elements.

30. The crash box as recited in claim 29, wherein,
the at least one outer hollow chamber further comprises upper and/or lower delimiting walls,
the at least one inner hollow chamber further comprises upper and/or lower delimiting walls,
the beads continue into the partition and into the upper and/or lower delimiting walls of the at least one outer hollow chamber, and
the beads continue into the partition and into the upper and/or lower delimiting walls of the at least one inner hollow chamber.

31. The crash box as recited in claim 16, wherein,
the at least one outer hollow chamber has a constant width of at least 20 mm over an entire longitudinal extent thereof from a vehicle-side end up to a bumper-side end, and
the at least one inner hollow chambers has a constant width of at least 20 mm over an entire longitudinal extent thereof from the vehicle-side end up to the bumper-side end.

32. A bumper arrangement of a motor vehicle, the bumper arrangement comprising:
two crash boxes as recited in claim 16; and
at least one crossmember which connects the two crash boxes to one another.

33. The bumper arrangement as recited in claim 32, wherein
the at least one outer hollow chamber is arranged closer to an end of the at least one crossmember than is the at least one inner hollow chamber, or
the at least one outer hollow chamber of the two crash boxes is arranged above the at least one inner hollow chamber.

34. The bumper arrangement as recited in claim 32, wherein,
the at least one crossmember comprises an upper fastening region, a lower fastening region, and a height,
the height of the at least one crossmember is greater than a cross-sectional height of the vehicle-side end portion of the two crash boxes,
the at least one outer hollow chamber of the two crash boxes is arranged above the at least one inner hollow chamber and is supported on the upper fastening region of the at least one crossmember, and
the at least one inner hollow chamber is supported on the lower fastening region of the at least one crossmember.

35. The bumper arrangement as recited in claim 32, wherein the two crash boxes are joined to the at least one crossmember.

36. The bumper arrangement as recited in claim 35, wherein the joining of the two crash boxes to the at least one crossmember is via a material bonding and/or via a welding.

37. A method for producing the bumper arrangement as recited in claim 32, the method comprising:
a first step of providing two multi-chamber hollow profiles comprising at least one outer hollow chamber and at least one inner hollow chamber;
a second step of introducing a slot into a bumper-side front portion of the two multi-chamber hollow profiles so as to separate and space apart the at least one outer hollow chamber from the at least one inner hollow chamber, thereby producing a crash box;
repeating the first step and the second step so as to provide two crash boxes; and
joining each of the two crash boxes to at least one crossmember.
